(19) United States
(12) Patent Application Publication
(10) Pub. No.: US 2026/0080241 A1
(43) Pub. Date: Mar. 19, 2026

(54) AUTOMATED GENERATION OF A FIELD SERVICE TECHNICIAN PRE-WORK BRIEF

(71) Applicant: Salesforce, Inc., San Francisco, CA (US)

(72) Inventors: Puneet DHALIWAL, Dublin, CA (US); Shreyaa SRIDHAR, Belmont, CA (US); Nafeez Salma Chittoor KHADER, Fremont, CA (US); Rajan SHAH, Yardley, PA (US); Niv GARBER, Degania Bet (IL); William CARPENTER, Brooklyn, NY (US); Sindhusree AITA, Sunnyvale, CA (US); Man Kit YAU, Burnaby (CA); Hao Hua GUAN, Alameda, CA (US); Abhishek DEWAN, Walnut Creek, CA (US); Christopher Ronald OLLENBURG, Littleton, CO (US)

(73) Assignee: Salesforce, Inc., San Francisco, CA (US)

(21) Appl. No.: 19/019,268

(22) Filed: Jan. 13, 2025

Related U.S. Application Data
(60) Provisional application No. 63/695,102, filed on Sep. 16, 2024.

(51) Int. Cl. G06N 3/08

(52) U.S. Cl. CPC G06N 3/08

(57) ABSTRACT

Methods, systems, and machine-readable media user generative artificial intelligence (AI) to generate a pre-work brief for display on a field service technician mobile device. An instruction to generate a pre-work brief is received. Work order data based on a field service technician user identifier associated with the instruction to generate the pre-work brief is retrieved. A generative AI prompt template is retrieved based on the work order data. A generative AI prompt is generated based on the prompt template and the work order data. The prompt is provided to a generative AI. The pre-work brief is received as an output of the generative AI. The pre-work brief is transmitted to the mobile device of the field service technician.

### CROSS-REFERENCE TO RELATED APPLICATION

This application claims the benefit of U.S. provisional patent application Ser. No. 63/695,102 , filed Sep. 16, 2024, which is incorporated herein by reference in its entirety.

### TECHNICAL FIELD

One or more implementations relate to the fields of systems that combine database systems and generative artificial intelligence systems; and more specifically, to automated generation of a field service technician pre-work brief.

### BACKGROUND ART

A field service technician may travel to a site of work to be performed, where the site and the exact nature of the work may be unfamiliar to the field service technician. Such work can include site evaluation work (e.g., for quote, bid, or insurance purposes), sales or customer service work, site premises construction or maintenance, installation or repair of indoor or outdoor appliance, fixture, or utility systems, information technology (IT) infrastructure work, energy generation or transmission infrastructure work, or landscaping, groundskeeping, or janitorial work, as but a few examples. A field service technician can be an agent of a private organization or a governmental entity. In some instances, a field service technician may be dispatched to perform ordered work by a dispatcher. A field service technician may make use of mobile information technology devices in the course of performing field work.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 is a block diagram illustrating a field service pre-work brief generation environment according to some example implementations.

FIG. 2 is a more detailed block diagram illustrating a field service pre-work brief generation service according to some example implementations.

FIG. 3 is a block diagram illustrating an example work order object.

FIG. 4 is a block diagram illustrating an example prompt template.

FIG. 5 is a user interface diagram illustrating an example generative AI input prompt template builder user interface.

FIG. 6 is a flow diagram illustrating an example method of generating a field service pre-work brief.

FIGS. 7 through 9 are flow diagrams illustrating example methods of retrieving data.

FIG. 10 is a flow diagram illustrating an example method of generating and transmitting a prompt to a generative AI or generative AI gateway.

FIG. 11 is a flow diagram illustrating an example method of automated generation of a field service pre-work brief using generative AI.

FIG. 12A is a block diagram illustrating an electronic device according to some example implementations.

FIG. 12B is a block diagram of a deployment environment according to some example implementations.

FIG. 13 is a block diagram of an example computer system.

### DETAILED DESCRIPTION

Upon or before arriving on site to perform ordered work, a field service technician may read and understand a pre-work brief, a written form or document concisely describing the work to be undertaken by the field service technician and its location, to assist and guide the field service technician in comprehending the location, nature, and scope of the ordered work before the field service technician commences the work. The pre-work brief can be written in natural-language prose, and in some instances can include one or more lists (e.g., bulleted or numbered lists) of items, and/or one or more headings. Use of a pre-work brief can reduce or eliminate a field service technician's need to query on-site individuals, such as homeowners, business premises personnel, or other field workers, to be guided to the place of the work and to understand the nature and scope of the work to be performed.

A pre-work brief can include, in some cases, step-by-step instructions describing how to perform the ordered work, to within a level of detail appropriate for the knowledge, skill, and experience of the particular field service technician ordered to perform the work, and/or can provide links to appropriate instructional resources. Such instructions or resource links can spare the technician from having to spend time looking up instructional material (e.g., by surfing the internet or requesting instructions from a dispatcher or other worker) when on site. The pre-work brief may also include time or cost budgets within which the work should be performed, which may take into account the schedule of the field service technician, e.g., information about other field service assignments the same technician may be scheduled to perform and estimated or predicted travel time requirements involved, and/or prices for the work that may have been agreed upon in advance. The pre-work brief can also serve as a checklist to ensure that the field service technician understands all parts of the work that may be needed to be performed, and thus to ensure successful, and in some cases minimally remunerable, completion of ordered work. For example, the pre-work brief may instruct that inviting a customer to inspect and approve performed work before leaving the site is within the scope of the work to be performed.

A pre-work may beneficially be composed in a language that the particular field service technician ordered to perform the work is most familiar with (e.g., a language other than English), and may be composed in plain language or in detailed technical language, as appropriate to the particular field service technician and the nature of the ordered work.

Timely and concisely composing a pre-work brief to usefully incorporate the work location, nature, and scope information helpful for performing the ordered work, while also being tuned to the particular knowledge, skill, and experience of the field service technician, can be a laborious human task. Accordingly, the following description describes implementations for automating the generation of a field service technician pre-work brief in ways that can take into account the information and factors described above. Using tools of generative artificial intelligence (“generative AI”), such as one or more large language models (LLMs) configured to generate natural-language outputs based on input prompts, the implementations described herein can generate a pre-work brief customized for the ordered work and the particular field service technician ordered to perform the work, within seconds, without human compositional effort.

### Multi-Tenant Environment

A multi-tenant system can be configured to serve multiple organizations, each as a tenant on the system. The system can include multiple information technology infrastructure clusters, known as a points of deployment (“pods”), configured to provide redundancy, load balancing, and high availability. Each pod can include hardware servers, software, and networking equipment collocated within a geographical area, and can host multiple organizations. The software can include, as examples, an application server, database server, a database, a file system, and a search system. In implementations as described herein, the software can further include a generative AI gateway, such as an LLM gateway, configured to provide prompt inputs to a generative AI model, such as an LLM. The prompts can be textual or can be of other modalities, such as image prompts, audio prompts, or video prompts. The LLM can be hosted by the multi-tenant system, e.g., on one of its pods, or can be hosted outside of the system and accessed via the internet. The generative AI gateway can be configured to interface with one or more different generative AI models, abstracting away the differences in inputs expected by the different models and the outputs provided by the different models back to the system. Each pod can host one or more environments for each tenant on the pod. The environments can include, as examples, one or more of a production or “live” environment, a development environment, a testing environment, an integration environment, and a training environment.

One or more tenant users of each environment may be designated as organization administrators (“admins”), bestowing administrative privileges them within the respective environment running on the pod. Other tenant users may be designated with other permissions levels, for example, as dispatchers or field service workers. Admins can be authorized, via their permissions levels, to configure different generative AI prompt templates for different scenarios.

The multi-tenant environment can incorporate one or more mobile devices. The one or more mobile devices can remotely interact with the multi-tenant environment (e.g., with a pod) via a wireless communications connection, e.g., a radio frequency connection such as a cellular telephone communication connection or Wi-Fi, using a web browser interface or a mobile device application (“app”) interface, as examples. The multi-tenant environment can intermittently or periodically transmit data to one or more of the mobile devices for storage thereon. Such intermittent or periodic data transmission to a mobile device can be referred to as “priming” the device. The primed data can be available on the mobile device for latest access by the mobile device irrespective of the mobile device's wireless communication capability subsequent to the priming. Thus, if a mobile device goes out of range of cellular communication or a Wi-Fi network, a user of the mobile device, such as a field service technician, can still access the primed data. Moreover, even when the mobile device has full connectivity to the multi-tenant environment, the priming of data can reduce or eliminate the time needed for data to be remotely transferred to the mobile device when it is desired to be accessed, thus speeding accessibility to the data on the mobile device.

### Field Service Pre-Work Brief Generation Service and Environment

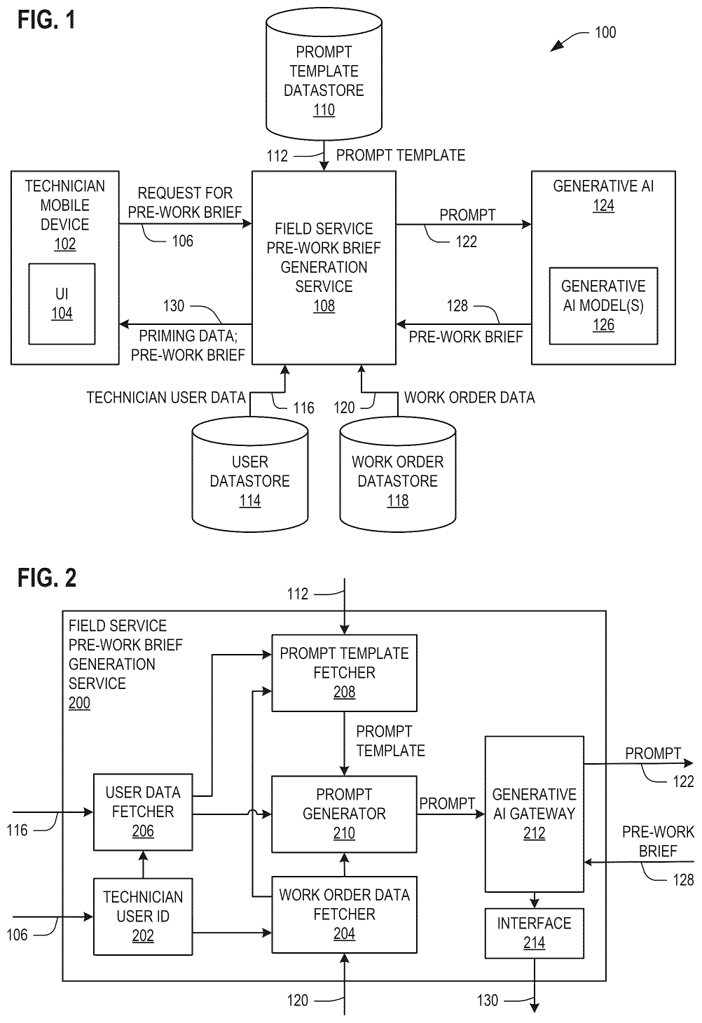

FIG. 1 illustrates an example field service pre-work brief generation environment 100, including a mobile device 102 and a field service pre-work brief generation service 108.

Environment 100 can, in some examples, operate within the context of a multi-tenant system or environment as described above, and as described in greater detail below. The mobile device 102 can be any computing device configured to provide a user interface (UI) 104 and configured with communication capabilities to communicate with other computing devices. As examples, the mobile device 102 can be a personal computer or mobile device such as a smartphone, tablet, or smart watch. The mobile device 102 can beneficially be a mobile device, providing the advantage that it can be used by a field service worker while on assignment (or between assignments) in the field.

The generation of a pre-work brief and delivery of the pre-work brief to the mobile device 102 can be triggered in a number of ways. As one example, the UI 104 of the mobile device 102 can include a navigation system that can retrieve and display field service records, such as work order records, that can include a screen or portion of a screen configured to display a field service pre-work brief associated with a particular field service record (e.g., with a particular work order record) when the screen is accessed. When a field service technician navigates to the screen or screen portion using the navigation system on the UI 104, the UI 104 detects this navigation and automatically triggers the pre-work brief generation to generate and display the pre-work brief on the screen or screen portion of the UI 104. In some examples, then, a request for a pre-work brief is sent from the mobile device 102 to the field service pre-work brief generation service 108 via connection 106, the field service pre-work brief generation service 108 generates the pre-work brief and returns it to the UI 104 via connection 130, and the pre-work brief is displayed on the screen or screen portion. In other examples, rather than making a request for a pre-work brief from the field service pre-work brief generation service 108, the mobile device 102 hydrates a pre-primed AI prompt template stored on the mobile device 102 with pre-primed data also stored on the mobile device 102 to generate an AI prompt, which the mobile device 102 then sends to the generative AI 124 or an intermediate generative AI gateway, which then sends the prompt to the generative AI 124. The generative AI generates the pre-work brief and returns it to the UI 104 or to the generative AI gateway, which then returns it to the UI 104, and the pre-work brief is displayed on the screen or screen portion. In still other examples, rather than the mobile device 102 hydrating a prompt template, an already-hydrated AI prompt is primed to the mobile device 102, and the AI prompt is transmitted to the generative AI 124 or gateway for generation of the pre-work brief.

As another example, the mobile device 102 can be configured to allow a user to input a natural-language query, which is sometimes referred to as a user utterance. The utterance can, for example, be representative of a field service pre-work brief generation request. The utterance may be transmitted to the field service pre-work brief generation service 108 via connection 106, in some instances after having been transcribed from audio data into textual data (e.g., using a deep-learning-based speech-to-text transcription model), and processed by the field service pre-work brief generation service 108, or to some preceding remote component that interprets the utterance as a request for a pre-work brief and subsequently transfers the request to the field service pre-work brief generation service 108. The field service pre-work brief generation service 108 can then generate the pre-work brief and transmit the generated pre-work brief back to the UI 104 via connection 130, responsive to the utterance.

The utterance can, in some examples, originate as audio data representing an oral/verbal input provided to the mobile device 102 via a microphone of or connected to the mobile device 102 and subsequently transcribed to textual data. For example, deep-learning-based speech-to-text transcription model (not shown) can be used to transcribe the utterance. The deep-learning-based speech-to-text transcription model can be hosted on the mobile device 102 itself, or can be hosted on another computing device (not shown), e.g., on the cloud, and accessed by the mobile device 102 via the internet. The mobile device 102 can provide the transcription model with the audio data and the transcription model can return a transcription of the utterance as textual data to the mobile device 102. In some examples, the mobile device 102 can be configured with specialized hardware circuitry capable of performing speech-to-text transcriptions. In some examples, the utterance remains as audio data and is not transcribed to textual data before being transmitted to field service pre-work brief generation service 108. In some examples, the utterance originates as textual data. For example, the mobile device 102 can include a keyboard (e.g., an on-screen keyboard) or other input arrangement by which the utterance can be entered and/or edited by typing.

In yet other examples, the generation of a pre-work brief can be triggered in accordance with a schedule, and the pre-work brief can be transmitted to the UI 104 via connection 103 at a scheduled or triggered time (e.g., along with other priming data), with or without the field service pre-work brief generation service 108 first requiring a request via connection 106 from the mobile device 102. For example, all pre-work briefs for work orders associated with scheduled service appointments for a particular day can be scheduled for generation and transmission to the respective technician mobile device 102 on the morning of the scheduled service appointment, or each pre-work brief can be scheduled for generation some number of hours in advance of an associated scheduled service appointment.

In still other examples, the generation of a field service pre-work brief and transmittal of the pre-work brief to the mobile device 102 can be triggered by location information. As one example, location data (e.g., GPS data or cellular positioning data) indicative of the location of the technician mobile device can be transmitted to the field service pre-work brief generation service 108, the field service pre-work brief generation service 108 can be configured to detect a proximity of the mobile device 102 to a work order or service appointment location (e.g., as may be stored in the work order datastore 118). This proximity detection can then trigger the field service pre-work brief generation service 108 to generate the pre-work brief for the corresponding work order and transmit the generated pre-work brief to the mobile device 102. As another example, rather than the mobile device 102 transmitting location data, the mobile device 102 can be configured to detect the proximity to the work order or service appointment location (e.g., as may be stored as primed data on the mobile device 102). This proximity detection can then trigger the mobile device to send a request for a corresponding pre-work brief to the field service pre-work brief generation service 108, which can then generate the pre-work brief and transmit the generated pre-work brief to the mobile device 102.

In examples in which a pre-work brief is generated and transmitted to the mobile device 102 upon request by the mobile device 102, the mobile device 102 can transmit a request via connection 106 to the field service pre-work brief generation service 108. A user identifier (user ID) of the user making the field service pre-work brief generation request can also be provided to the field service pre-work brief generation service 108 along with the request for the pre-work brief. The field service pre-work brief generation service 108 can, for example, comprise software running on one or more computing devices other than the mobile device 102, e.g., in the cloud. In such examples, connection 106 may be via the internet or an intranet, and may include various intermediary network infrastructure devices and connections. In some examples, the field service pre-work brief generation service 108 may run at least in part on the mobile device 102. The field service pre-work brief generation service 108 can be configured to return to the user interface 104 of the mobile device 102 an output comprising the requested generated field service pre-work brief. The field service pre-work brief generation service 108 may therefore connect to one or more datastores to retrieve records relevant to the creation of the pre-work brief. As examples, the field service pre-work brief generation service 108 can connect to user datastore 114 via connection 116 to retrieve field service technician user data, and to work order/service appointment datastore 118 via connection 120 to retrieve work order data. For example, the field service technician user data can comprise data representative of (e.g., used to populate the attribute values of) user objects. For example, the work order data can comprise data representative of (e.g., used to populate the attribute values of) work order objects, work order line item objects, and/or service appointment objects.

The field service pre-work brief generation service 108 can be configured to generate a field service pre-work brief based at least in part on output of a generative AI 124. The field service pre-work brief generation service 108 can create a prompt that can be based on a prompt template and can send the created prompt as input to the generative AI 124 via connection 122. The field service pre-work brief generation service 108 may therefore connect to one or more datastores to retrieve relevant generative AI prompt templates that may be used to create generative AI prompts. A generative AI prompt template can comprise a drafted generative AI prompt having certain variable placeholders, sometimes referred to as merge fields, that can subsequently be filled to create a prompt in a process referred to as hydration. As an example, the field service pre-work brief generation service 108 can connect to prompt template datastore 110 via connection 112 to retrieve an appropriate AI prompt template. Connections 112, 115, and 120 are illustrated as unidirectional in FIG. 1 for the sake of simplicity, but can be bidirectional. Field service pre-work brief generation service 108 can, for example, transmit data query language (DQL) queries (e.g., Structured Query Language (SQL) or Salesforce Object Query Language (SOQL) queries) to datastores 110, 114, 118 via connections 112, 116, 120.

In some examples, the generative AI 124 may be executed using the same one or more computing devices used to execute the field service pre-work brief generation service 108, in which case the prompt can be transmitted from the field service pre-work brief generation service 108 to the generative AI 124 without a network as an intermediary. In other examples, the generative AI 124 is provided on one or more separate computer systems from the one or more computer systems used to run the field service pre-work brief generation service 108, and AI input and output connections 122, 128 may be via the internet, for example. For example, the generative AI 124 may be provided as a cloud service. Examples of the generative AI 124 include Google Gemini 1.5 Pro, OpenAI GPT-4 or GPT-4o, and Anthropic Claude 3.5. GPT-4 is based on eight models with 220 billion parameters each, for a total of about 1.76 trillion parameters, connected by a mixture of experts (MoE). GPT-4o has a token limit of 128,000 tokens. Gemini 1.5 Pro has 1.5 trillion parameters and a token limit of 1,000,000 tokens. A token limit may dictate the combined size of both an input (including prompt and context data) and an output of the generative AI 124.

The generative AI 124 can include one or more generative AI models 126. Where more than one generative AI model 126 is used, the models can work each accomplish different AI functions and/or can work in concert with each other to produce generative AI outputs. For example, one or more of the models 126 can comprise an LLM. The form of the generative AI outputs can be of any modality, e.g., textual data, audio data, video data, pictorial data, audiovisual data, code data, or interactive or game data, as examples. In some examples, the generative AI 124 can be trained on the work order data from work order datastore 118, such that the model 126 knows and understands this data, and is capable of directly generating a pre-work brief based on the work order data. The generative AI 124 can therefore return a pre-work brief to field service pre-work brief generation service 108 via connection 128, and the pre-work brief can subsequently be returned to mobile device 102 via connection 130. In other examples, the generative AI 124 is not trained on the work order data from work order datastore 118, but can be provided this data as context data via connection 122. In such examples, generative AI model 126 is capable of generating a pre-work brief based on the work order data provided to the generative AI 124 as context data. The generative AI 124 can therefore return the generated pre-work brief to the field service pre-work brief generation service 108 via connection 128, and the pre-work brief can subsequently be returned to mobile device 102 via connection 130.

FIG. 2 illustrates an example field service pre-work brief generation service 200 according to some example implementations. The field service pre-work brief generation service 200 of FIG. 2 can correspond, for example, to the field service pre-work brief generation service 108 of FIG. 1. In some examples, the field service pre-work brief generation service 200 can receive a requesting field service technician user ID 202 as input via connection 106, e.g., from a mobile device 102. The field service pre-work brief generation service 200 can resolve a field service technician user ID from a requesting field service technician as the requesting user ID 202 in instances where it is a field service technician who initiates the query and provides the original user utterance requesting a search of field service data. The field service pre-work brief generation service 200 can further include a user data fetcher 206 that can be configured to create and execute an appropriate DQL query to search a user datastore, such as user datastore 114 in FIG. 1, via connection 116, e.g., to determine additional information about a field service technician based on the field service technician's user ID 202.

The field service pre-work brief generation service 200 of FIG. 2 can further include a work order data fetcher 204 configured to execute an appropriate DQL query to search a work order datastore 118 via connection 120. In some examples, such a datastore 118 may comprise multiple different datastores that can be separately searched, the details of which are not illustrated in FIG. 2 for the sake of simplicity. For example, the work order data fetcher 204 can be configured to generate a DQL query based on rules and/or one or more DQL query templates (not shown in FIG. 2). For example, the work order data fetcher 204 can execute a generated DQL query against the work order datastore 118 via connection 120 to return requested data, e.g., work order data, work order line item data, and/or service appointment data that can be used in generating the field service pre-work brief. The field service pre-work brief generation service 200 can further include an interface 214 provide a resultant pre-work brief as an output of the field service pre-work brief generation service 200 to a mobile device 102 via connection 130.

The field service pre-work brief generation service 200 of FIG. 2 can further include a prompt template fetcher 208 configured to generate and execute an appropriate DQL query to fetch an AI prompt template from prompt template datastore 110 via connection 112. The field service pre-work brief generation service 200 of FIG. 2 can further include a prompt generator 210 configured to generate a generative AI prompt by filling in (“hydrating”) variable placeholders (merge fields) in a prompt template with data values and packaging context data. A retrieved prompt template can be provided from the prompt template fetcher 208 to the prompt generator 210 for this purpose. The prompt generator 210 can be configured to convert a prompt template provided by the prompt template fetcher 208 into a prompt based on data provided by the user data fetcher 206 and/or the field service technician user ID 202, the work order service appointment data fetcher 204, and/or from a generative AI, such as generative AI 124 in FIG. 1, via connection 128, as described below.

The field service pre-work brief generation service 200 of FIG. 2 can further include a generative AI gateway 212 (e.g., an LLM gateway). The generative AI gateway 212 can include one or more application programming interfaces (APIs) for one or more respective generative AIs, thus abstracting away implementation details for the different generative AIs from the perspective of the rest of the field service pre-work brief generation service 200. The generative AI gateway 212 can integrate with different generative AI models and providers, exposing them as, in effect, a unified API from the perspective of any application that may use a generative AI. The use of the generative AI gateway 212 advantageously permits easier and more seamless swapping-out of one generative AI for another as the generative AI to be used by the field service pre-work brief generation service 200. In addition to offering this horizontal scalability, the generative AI gateway can include a trust layer that can perform masking of personally identifiable information (PII masking), payment card information (PCI masking), and protected health information (PHI masking) that may be provided in a generative AI prompt before that information is transmitted to a third-party generative AI, thus preventing security leaks of sensitive information. Still further, the generative AI gateway 212 can handle transformation of a prompt as a normalized payload into a vendor-specific request payload. Still further, the generative AI gateway can transmit the request payload using the appropriate security credentials, which may be specific to the generative AI selected to be used, the user or user organization, or both. In some examples, the generative AI gateway 212 is provided as a separate service, e.g., a micro-service, e.g., a cloud-based service.

Having performed its various functions as described above, which may vary in different implementations, the generative AI gateway 212 can transmit a prompt via connection 122 as an input to a selected generative AI and can receive, in return, an output of the selected generative AI via connection 128. In accordance with instructions that may be provided in the AI prompt, the generative AI output can, for example, take the form of a formatted or unformatted prose text output that can include, in some instances, one or more numbered or bulleted lists and/or one or more section headings. In accordance with instructions that may be provided in the AI prompt, the generative AI output can provide concise instructions describing the work to be undertaken by the field service technician and its location. For example, in accordance with instructions provided that may be in the AI prompt, the generative AI output can include step-by-step instructions describing how to perform the ordered work, to within a level of detail appropriate for the knowledge, skill, and experience of the particular field service technician, and/or can provide links to appropriate instructional resources. In accordance with instructions that may be provided in the AI prompt, the generative AI output may also include time or cost budgets within which the work should be performed. In accordance with instructions that may be provided in the AI prompt, the generative AI output can provide checklist listing parts of the work to be performed. In accordance with instructions that may be provided in the AI prompt, the generative AI output may beneficially be composed in a language that the particular field service technician ordered to perform the work is most familiar with (e.g., a language other than English), and may be composed in plain language or in detailed technical language, as appropriate to the particular field service technician and the nature of the ordered work. For example, the user data fetcher 206 may fetch from the user datastore 114 data about the field service technician indicating a preferred language in which the field service pre-work brief should be written. For example, the preferred language may be stored as an attribute of a user object stored in the user datastore 114.

### Field Service Data Record Objects

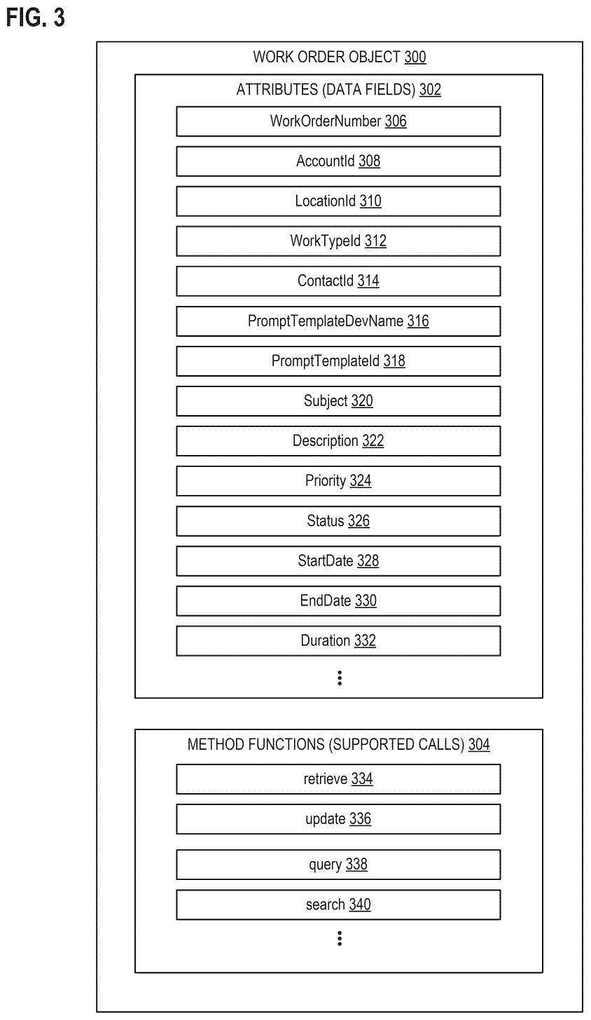

FIG. 3 illustrates an example work order object 300. Objects can store, as attributes, information relative to an instance of an entity type. These attributes are the data fields of the object. The data in the data fields can be stored in a datastore, such as work order datastore 118 shown in FIG. 1. Objects can also have associated with them a number of method functions (supported calls), which are software routines associated with the object that can operate on the object's attribute data. Some of the attributes can include IDs that point to other objects that may, in turn, hold data in their own attributes particular to these other objects. In some examples, the field service pre-work brief generation implementations described herein can fetch one or more attributes of one or more of objects 300 and/or one or more attributes of objects pointed to by one or more of the attributes of one or more of objects 300 as part of gathering context data to a generative AI on which to base a pre-work brief to be composed by the generative AI.

FIG. 3 illustrates an example work order object 300 that can represent field service work to be performed for a customer by one or more field service technicians. The work order object 300 can be populated with a number of attributes (data fields) 302 and can also have associated with it a number of method functions (supported calls) 304 that can operate on the attributes 302. As illustrated, the attributes 302 of the example work order object 300 can include WorkOrderNumber 306, AccountId 308, LocationId 310, WorkTypeId 312, ContactId 314, PromptTemplateDevName 316, PromptTemplateId 318, Subject 320, Description 322, Priority 324, Status 326, StartDate 328, EndDate 330, and Duration 332. In some examples, the work order object 300 can include one or more other attributes 302, such as Address, AssetId, AssetWarrantyId, BusinessHoursId, CaseId, City, Country, CurrencyIsoCode, Discount, DurationInMinutes, DurationType, EntitlementId, GeocodeAccuracy, GrandTotal, IsClosed, IsGeneratedFromMaintenancePlan, IsStopped, LastReferencedDate, LastViewedDate, Latitude, LineItemCount, LocationId, Longitude, MaintenancePlanId, MaintenanceWorkRuleId, MilestoneStatus, MinimumCrewSize, OwnerId, ParentWorkOrderId, PostalCode, Pricebook2Id, ProductServiceCampaignId, ProductServiceCampaignItemId, PromptTemplateDevName, PromptTemplateId, RecommendedCrewSize, ReturnOrderId, ReturnOrderLineItemId, RootWorkOrderId, ServiceAppointmentCount, ServiceContractId, ServiceDocumentTemplate, ServiceReportLanguage, ServiceReportTemplateId, ServiceTerritoryId, SlaExitDate, SlaStartDate, State, StatusCategory, StopStartDate, Street, Subtotal, SuggestedMaintenanceDate, Tax, and/or TotalPrice. As illustrated, the method functions 304 of the example work order object 300 can include retrieve 334, update 336, query 338, and search 340. In some examples, the work order object can include one or more other method functions 304, such as create, delete, describeLayout, describeSObjects, getDeleted, getUpdated, undelete, and/or upsert.

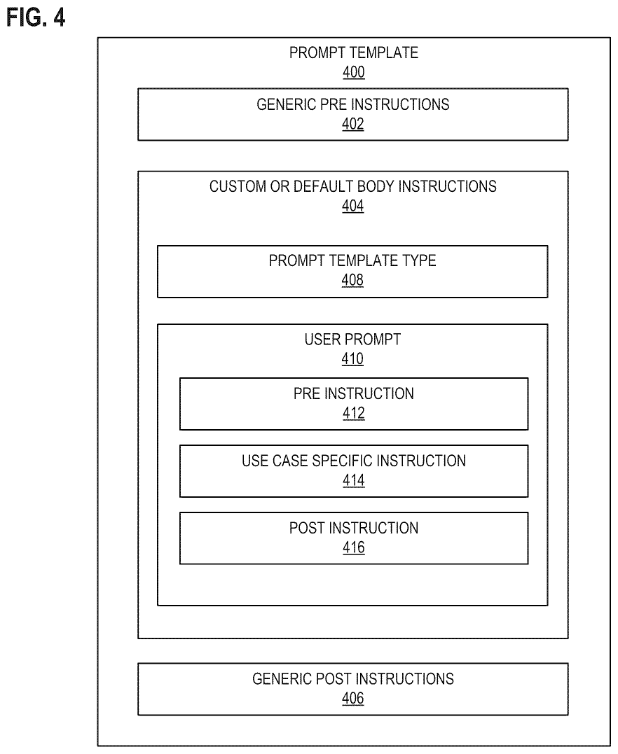

The PromptTemplateId data field 318 can specify an Id of an AI prompt template, as may be stored in the prompt template datastore 110. FIG. 4 illustrates an example prompt template 400, which can include generic pre instructions 402, custom or default body instructions 404, and generic post instructions 406, each of which comprise natural-language text that can include data, e.g., numerical data, tabular data, or other data. Slots for the data can be provided in the template 400 as merge fields. The generic pre instructions 402 and generic post instructions 406 can be written to apply for a wide variety of prompts to a generative AI, and not just to prompts used to generate pre-work briefs. For example, the generic pre instructions 402 and generic post instructions 406 can contain information about a multi-tenant environment system policy. The system policy information in the generic post instructions 406 can be all or partially different from the system policy information in the generic pre instructions 402, or can be all or partially the same. Repetition of some of the system policy information after the user prompt can reinforce the system policy information as processed by the generative AI 124. For example, one or more directives specifying the language, tone and style can be repeated in the generic post instructions 406 to better insure that these directives are followed by the generative AI 124. The body instructions 404 can be written specifically to generate pre-work briefs. Default body instructions 404 can be supplied, which can be modified or re-written by an administrator, in the context of a multi-tenant environment. The body instructions 404 can include, for a given prompt template type 408, a user prompt 410 that can include a pre instruction 412, a use case specific instruction 414, and a post instruction 416. In some examples, some of the fields, such as the post instruction 416, can be empty (omitted).

For example, in the context of a prompt template 400 for generative of a pre-work brief, the pre instruction 412 can include text such as, “You are my assistant, and I am a field service technician. You are giving me a summary of my work that needs to be done. You must strictly follow my instructions that include the formatting rules below. ”

For example, in the context of a prompt template 400 for generation of a pre-work brief, the use case specific instruction 414 can include text such as, “Use natural language to describe the overall work plan, by using clear, concise, non-redundant language. Provide all work details, including customer contact information if available, by synthesizing and combining similar data values from multiple fields into compound and complex sentences. Only when customer contact data is provided is it advisable to suggest that I contact the customer with information provided. Completely ignore empty value data. Do not reap information in the output. Avoid repetitive words. Do not sound robotic. Do not list tasks individually. Instead, use conjunctions, subordinating conjunctions, and/or discourse markers to create a natural and conversational style. Do not mention the source of data in the output. Disregard the value of the “execution order”. Do not suggest content or generate answers that you do not have data or basis for. Include in the following data in your work summary, but do not list it directly:

###Work Order Data:
Account name: {!$Input:WorkOrder.Account. Name}.
Location: {!$Input:WorkOrder.Location.Name} {WorkOrder.Address}.
Work Order Number: {!$Input:WorkOrder.WorkOrderNumber}
Subject: {!$Input:WorkOrder.Subject}
Description: {$Input:WorkOrder.Description}
Priority: {!$Input:WorkOrder.Priority}
Status: {!$Input:WorkOrder.Status}
Start-End time of operation: {!$Input:WorkOrder.StartDate}-!$Input:WorkOrder.EndDate}{!$Input:WorkOrder.ParentWorkOrder.Duration}
Case Note: {!$Input:WorkOrder.Case.Reason}
Execution Order: {!$Input:WorkOrder.PreWorkBriefPromptTemplate}
Customer Contact Name: {!$Input:WorkOrder.Contact.Name}
Customer Contact Number: {!$Input:WorkOrder.Contact.Phone}
Now generate the work summary in {!$Input:User.PreferredLanguage}. ”

In the above example, merge fields are denoted as enclosed in curly braces. These merge fields are hydrated (replaced by the relevant object data as may be drawn from data stores such as the work order datastore 118 and the user datastore 114 by field service pre-work brief generation service 108 in the example of FIG. 1. The hydration can be performed by prompt generator 210 in the example of FIG. 2.

### Prompt Template Builder

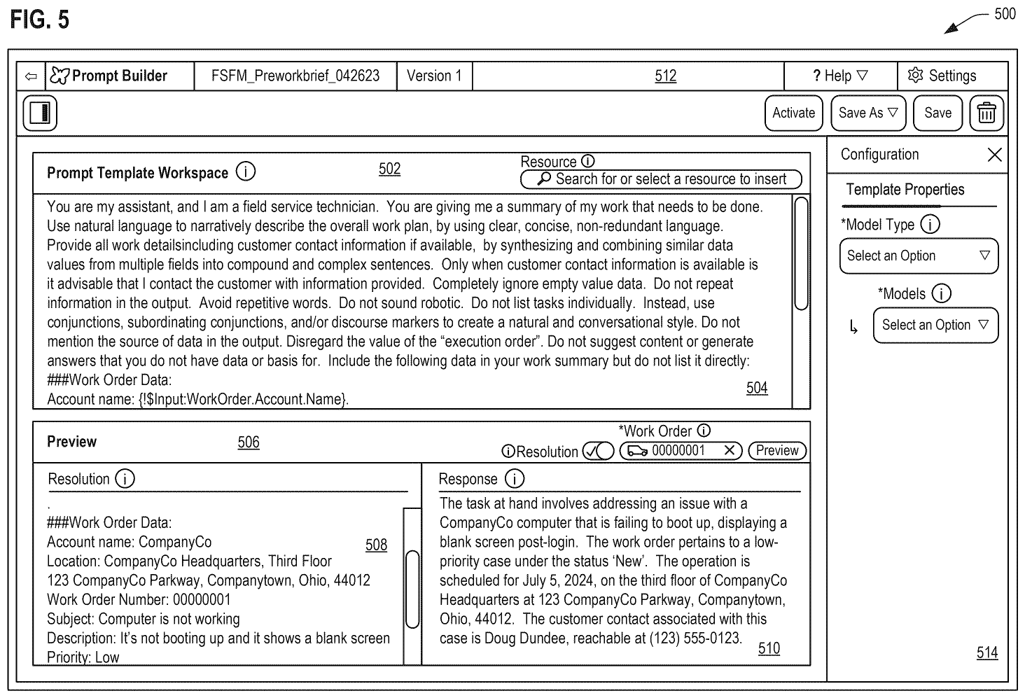

FIG. 5 shows an example generative AI input prompt template builder user interface 500 that can be used by a template drafting user (e.g., an administrator in a multi-tenant system) to write, edit, verify, save, and/or activate AI prompt templates, such as may be stored in prompt template datastore 110 and used by prompt generator 210 to generate a prompt to transmit to a generative AI via the generative AI gateway 212. The template builder 500 can include a prompt template workspace 502 and a preview 506. The prompt template workspace 502 can include a text area field 504 where an AI prompt template can be drafted. The text in the text area field 504 can correspond to the user prompt 410 of FIG. 4. The prompt template can include variable placeholders, sometimes referred to as merge fields, which in the illustrated example are denoted by being enclosed in matching opening and closing curly braces. For example, the illustrated AI prompt template shown in FIG. 5 includes a merge field for the current datetime and a merge field for the initial user utterance. The illustrated AI prompt template shown in field 504 in FIG. 5 includes instructions to a generative AI to determine start and end datetimes from the user utterance, using the current datetime for context. A prompt template such as the one shown in field 504 can be used, for example, by field service pre-work generation service 108 in FIG. 1 or 200 in FIG. 2.

The preview 506 can include a resolution field 508 that shows an example prompt, that is, the prompt template as hydrated by substituting example data for the merge fields in the template. The resolution field 508 allows the drafting user to see what a template will look like when hydrated into a completed generative AI prompt. For example, the prompt template can be saved and stored to prompt template datastore 110 as shown in FIG. 1. The preview 506 can further include a response field 510 that displays the output of a selected generative AI given the prompt shown in the resolution field 508 as input. To obtain this generative AI output, the prompt, as shown in field 508, is transmitted to the generative AI, and the output of the generative AI is returned to the prompt builder tool. The template builder 500 can further include a title/menu bar 512 that can include a title and version number of the AI prompt template being worked on in the prompt builder 500, help and settings buttons, and buttons to activate/deactivate, save, and delete the template. The template builder 500 can further include a configuration pane 514 wherein one or more selections of a generative AI model type and a generative AI model can be made, via drop-down selection controls, for example.

### Pre-Work Brief Generation Methods

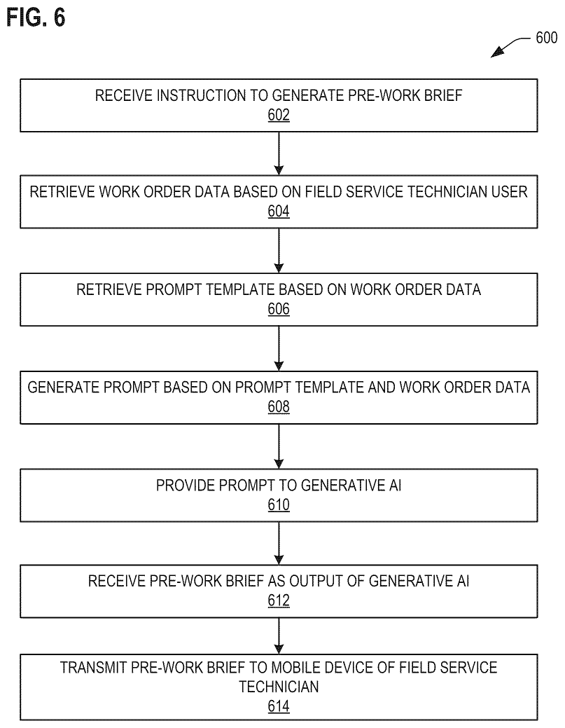

FIG. 6 shows an example computer-implemented method 600 of generating a field service pre-work brief. The method 600 can be performed for example, by field service pre-work generation service 108 in FIG. 1 or 200 in FIG. 2. In step 602, instructions to generate a pre-work brief are received. In some examples, the instructions are received by a mobile device, such as mobile device 102 in FIG. 1. The instructions can generally be triggered as discussed above, as examples, in association with priming of a mobile device, at a certain time, or upon access of a certain portion of a UI 104 of a mobile device 102, or upon updating or new scheduling of a service appointment. In some examples, the instructions are received from a schedule service, a cron job, or the like that can trigger execution of software routines at preset times or regular intervals.

In step 604, work order data is retrieved based on a field service technician user associated with the instruction to generate the pre-work brief. In some examples, a device associated with the field service technician user can be the sender of the instruction to generate the pre-work brief. In other examples, e.g., in which the instructions are received from a schedule service, a cron job, or the like that can trigger execution of software routines at preset times or regular intervals, the field service technician user identity can be specified in the instruction to generate the pre-work brief. In some examples, the some or all of the work order data can be retrieved from a work order datastore 118, e.g., using a work order data fetcher 204. For example, the work order data can be retrieved using one or more DQL queries. In some examples, some or all of the work order data can be sent by the field service technician mobile device, e.g., along with the instruction to generate the pre-work brief. The specification of the field service technician user can ensure that only work order data pertaining to the specified field service technician user is retrieved in step 604.

Although not shown in FIG. 6 for the sake of simplicity, the method 600 can also include retrieving user data associated with a user. For example, a user record can be queried from user datastore 114 by user data fetcher 206, e.g., using a DQL query, e.g., to determine a preferred language of the field service technician user for whom the pre-work brief is to be generated. In some examples, the preferred language is stored as an attribute of a user object for the field service technician.

In step 606, a prompt template is retrieved based on the work order data. The prompt template can be retrieved, for example, from a prompt template datastore 110, e.g., using a prompt template fetcher 208. For example, the prompt template can be retrieved using a DQL query. The prompt template can be retrieved, for example, based on a prompt template ID specified in the work order data, such as PromptTemplateId 318 in work order object 300 as illustrated in FIG. 3. The specification of the prompt template ID in the work order data can ensure that a correct prompt template is selected as one useful for processing information specific to the work order data, providing the benefit that different kinds of work orders can invoke different prompt templates. This allows an administrator to configure a certain prompt to be used for work orders in one geographic region and a different prompt to be used for work orders in another geographic region, as an example. Each different prompt template may provide different instructions to a generative AI and/or may include different work order information in the merge fields such that the output pre-work brief can be customized for the work order or the type of work order. The selected prompt template can include one or more directives instructing a generative AI to generate and return a pre-work brief based on the work order data.

In step 608, a prompt can then be generated based on the prompt template and the work order data. The prompt can be generated, for example, by hydrating the prompt with the work order data and/or user data retrieved in step 604. In step 610, the prompt can be provided to a generative AI, e.g., generative AI 124 in FIG. 1. In some examples, the prompt can be provided in step 610 to the generative AI via a generative AI gateway, e.g., generative AI gateway 212 in FIG. 2. The generative AI can generate and return the requested pre-work brief based on the work order data provided in or with the prompt as context data. In step 612, the generated pre-work brief is received as the output of the generative AI and, in step 614, is transmitted to a mobile device of a field service technician, e.g., mobile device 102 in FIG. 1. The field service technician can then access and read the generated pre-work brief.

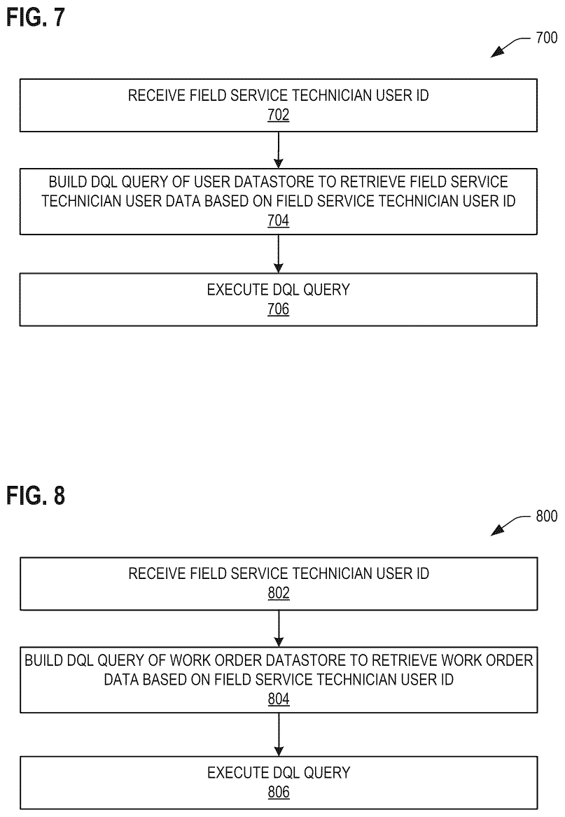

FIG. 7 illustrates an example method 700 of retrieving data field service user data, as may be performed, for example, by user data fetcher 206 in FIG. 2. In step 702, a field service technician user ID is received. For example, the field service technician user ID can be received as part of a pre-work brief trigger process as described above. For example, a field service technician mobile device 102 may transmit a request to generate a pre-work brief, which request can contain the field service technician user ID. The request need not be a request for a pre-work brief specifically, but may be a more general request for priming, which process can include providing to the mobile device 102 (a) one or more pre-work briefs, or (b) one or more prompts to generate one or more pre-work briefs, or (c) one or more prompt templates used to generate prompts to generate one or more pre-work briefs. In other examples, the field service technician user ID is not received from the mobile device 102, but is received as part of a scheduled or regular routine, such as a priming routine.

In step 704, a DQL query of a user datastore (e.g., user datastore 114 in FIG. 1) is built to retrieve field service technician user data based on the received field service technician user ID. The DQL query can be built, for example, using a ruleset designed to create a DQL query that returns the requested field service technician user data. The ruleset can function to create a well-formed, syntactically correct DQL query that executes without error. For example, the ruleset can comprise a DQL query template containing DQL words, phrases, and commands with variables that can be filled in with the relevant values used to limit the resultant query. The ruleset can be hard-coded into the user data fetcher 206, or can be user-defined and editable and stored in another datastore (not shown) that is accessible to the field service pre-work brief generation service 108. As an example, the DQL query template can be “SELECT User.PreferredLanguage FROM User WHERE User.UserId={UserId}”. After resolving and filling in the variable field {UserId}, the template results in a ready-to-execute DQL query. In example implementations, a ruleset may result in different templates being selected and/or different DQL query forms being constructed depending on what user data may be requested. In step 706, the DQL query may then be executed to retrieve the field service technician user data.

FIG. 8 illustrates an example method 800 of retrieving work order data, as may be performed, for example, by work order data fetcher 204 in FIG. 2. In step 802, a field service technician user ID is received, which can be as described above. In step 804, a DQL query of a work order datastore (e.g., work order datastore 118 in FIG. 1) is built to retrieve work order data based on the received field service technician user ID. The DQL query can be built as described above. In step 806, the DQL query may then be executed to retrieve the work order data. In some examples, multiple DQL queries can be built and executed to retrieve the work order data. The work order data can include, for example, data stored as attributes of a work order object, and in some instances can further include data stored as attributes of other objects referenced by attributes of the work order object, and in some instances, data stored as attributes of still other objects referenced by attributes of the other objects, and so on. Thus, DQL queries may be run recursively until all relevant data is retrieved.

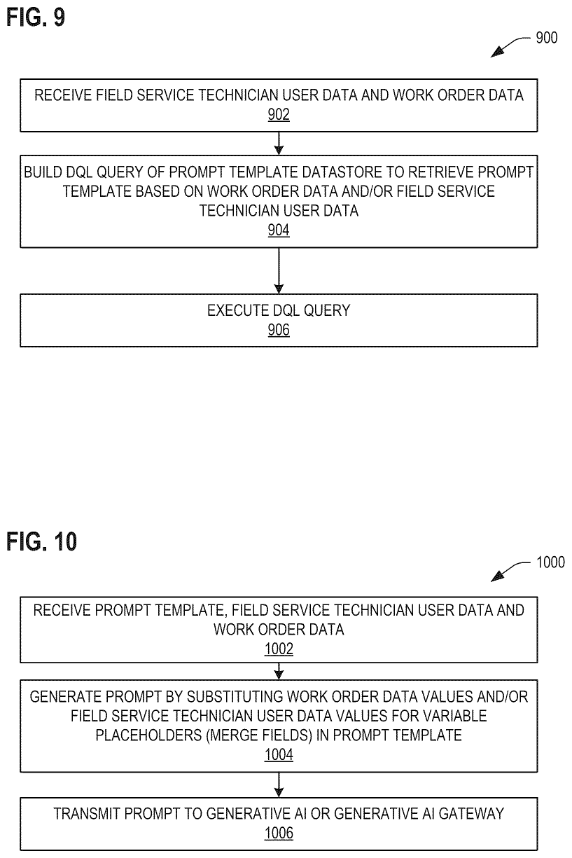

FIG. 9 shows an example method 900 of retrieving an AI prompt template, as may be performed, for example, by prompt template fetcher 208 in FIG. 2. In step 902, field service technician user data and work order data is received, which can be as described above, e.g., with regard to FIGS. 7 and 8. In step 904, a DQL query of a prompt template datastore (e.g., prompt template datastore 110 in FIG. 1) can be built to retrieve the prompt template. The DQL query can be built as described above. In some examples, the DQL query can be based on the field service technician user data and/or the work order data. For example, basing the DQL query on the work order data allows a particular prompt template to be selected relevant to the particular work order for which a pre-work brief is to be generated, thus allowing greater customization of pre-work brief generation. Not only can the pre-work brief be generated on the work order data by virtue of such work order data being provided to a generative AI as context data in a prompt provided to the generative AI, but the pre-work brief can also be generated based on customized directives in user-defined text of the prompt itself (e.g., as drafted or edited by an administrator, as described above with regard to FIG. 5), which can vary in accordance with the work order data. For example, a DQL query can be built to select one prompt based on the work order data showing that the work order is for one geographic region, and to select another, different prompt based on the work order data showing that the work order is for another, different region. As an example, the DQL query template can be “SELECT PromptTemplate.PromptTemplateText FROM PromptTemplate WHERE PromptTemplate.PromptTemplateId={WorkOrder.PromptTemplateId}”, where WorkOrder.PromptTemplateId can refer to the value of the PromptTemplateId attribute 318 in the work order object 300. In step 906, the DQL query may then be executed to retrieve the AI prompt template. This template can then be hydrated to complete an AI prompt for sending to a generative AI, e.g., via a generative AI gateway, as described above, and as described below with regard to FIG. 10.

FIG. 10 shows an example method 1000 of generating and transmitting a prompt to a generative AI or generative AI gateway, as may be performed, for example, by prompt generator 210 in FIG. 2. In step 1002, a prompt template, field service technician data, and work order data are received, which can be as described above with regard to FIGS. 1, 2, 7, 8, and 9. In step 1004, a prompt can be generated by substituting work order data values and/or field service technician user data values for variable placeholders (merge fields) in the received prompt template. In step 1006, the prompt can be transmitted to a generative AI, such as generative AI 124 in FIG. 1, or a generative AI gateway, such as generative AI gateway 212 in FIG. 2.

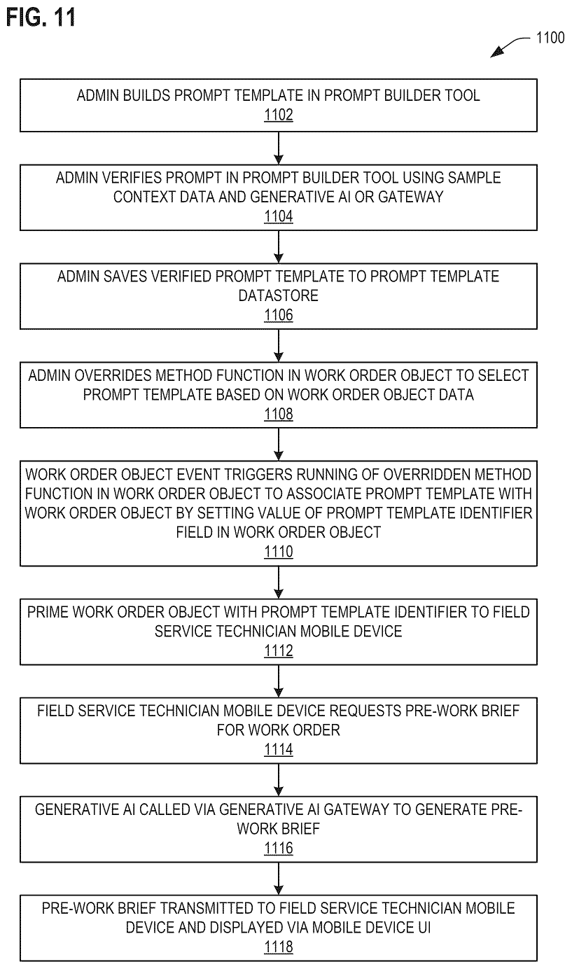

FIG. 11 shows an example method 1100 of automated generation of a field service pre-work brief using generative AI in the context of a multi-tenant environment as described above. As described above with regard to FIG. 5, in steps 1102, 1104, and 1106 an administrator of a tenant organization in a multi-tenant service can build, verify, and save a prompt template in a prompt builder tool. The verification of the prompt in step 1104 can use sample context data and a generative AI or generative AI gateway. In step 1108, the admin can also override a method function (e.g., a lifecycle hook) in a work order object to select a prompt template based on work order object data. The method function can be, for example, a create (constructor) or update method function. As examples, the method function can be overridden by substituting or re-writing code in the method function, or by changing a preference setting that effectively accomplishes the same. The overridden method function can be configured to write the prompt template identifier of a prompt template (e.g., of a prompt template stored in the prompt template datastore 110) to the work order object, e.g., based on one or more other attributes of the work order object. In the context of a multi-tenant system, a lifecycle hook is a callback method triggered at a specific phase of a component instance's lifecycle. Steps 1102, 1104, 1106, and 1108 can be performed by an administrator using any computing device with access to the multi-tenant environment.

In step 1110, a work order object event (e.g., the creation of a work order object or updating of a work order object with attribute data) triggers the running of the overridden method function in the work order object to associate the earlier saved prompt template with the work order object by setting a value of the prompt template identifier field in the work order object. In step 1112, the work order object can then be primed with a prompt template identifier (e.g., a value of PromptTemplateId 318 in FIG. 3) to a field service technician mobile device (e.g., mobile device 102 in FIG. 1). The priming can be performed as described above and as described in greater detail below.

In step 1114, the field service technician mobile device can request a pre-work brief for a work order. The request can be, for example, to the field service pre-work brief generation service 108 of FIG. 1 or 200 of FIG. 2 as described above. In step 1116, responsive to this request, a generative AI (e.g., generative AI 124 in FIG. 1) can be called via a generative AI gateway (e.g., generative AI gateway 124 in FIG. 2) to generate the requested pre-work brief. For example, the generative AI can be called with a prompt that is based on a prompt template identified by the prompt template identifier in the work order object. The prompt can be based on the prompt template by hydrating the prompt template to substitute work order data for merge fields in the prompt template, as described above. The generative AI can generate the pre-work brief, e.g., based on the prompt template and based on work order data in the work order object, and can return the generated pre-work brief. In step 1118, the pre-work brief can then be transmitted to the requesting field service technician mobile device and display via the mobile device UI (e.g., UI 104 in FIG. 1).

Multiple prompt templates can be defined by an administrator in steps 1102, 1104, and 1006. Method 1100 permits for choosing a single appropriate one of the multiple defined prompt templates for each work order programmatically, priming this information to a field service technician mobile device, and calling a generative AI gateway to generate the pre-work brief. The systems and methods described herein permit the programmatic prompt template selection logic to be custom-coded for each individual organization.

### Mobile Device Priming

When the UI 104 (e.g., web browser interface or mobile device app) of the mobile device 102 has connectivity to the multi-tenant environment, it can receive data from one or more servers of the multi-tenant environment and can regularly (e.g., intermittently or periodically) synchronize data with the servers of the multi-tenant environment. If the mobile device 102 subsequently loses connectivity with the multi-tenant environment, causing the UI 104 to go offline, the UI 104 can display a notification indicating the offline status (e.g., in a top navigation bar of the UI 104). Data changes made on the mobile device 102 while the UI 104 is offline can be added to a pending uploads queue (e.g., in the order they occur).

In the priming process, the mobile device 102 can be configured to download, from the multi-tenant environment, data related to the user's assigned service appointments upon user login to the UI 104 and/or according to a schedule or timer. The priming can ensure that data useful to a field service technician is available even if internet connectivity of the mobile device 102 is lost. The amount of time taken to prime the mobile device 102 can depend on the volume of data to be transferred. The UI 104 can be configured to display an error message if a network error occurs during priming, causing priming to stop. The UI 104 can be configured to automatically or manually (e.g., upon a user interaction with UI 104) resume priming to synchronize data when the mobile device 102 regains internet connectivity. The data that the UI 104 primes for each user can be based, for example, on field service data, e.g., on the user's assigned service appointments, work orders, and work order line items, within a specified time period. The field service data (e.g., data objects pertaining to service appointments, work orders, work order line items, and assets) can include references to other data objects. For example, the references may be to object IDs of other objects. The References in the field service data can be primed to a certain depth (e.g., to a depth of 3), with certain exceptions, in some examples.

In some examples, service appointments for the field service technician user, within the time range specified, are primed as key objects. In some examples, the time range can have a default of 45 days before and after the current day. In some examples, this time range value can be configured, e.g., by a field service technician, dispatcher, or administrator. In some examples, work orders, work order line items, and assets referenced by the primed service appointments are also primed as key objects. In some examples, other objects referenced by the above-mentioned key objects are primed, e.g., to a depth of 3. This priming means that the UI 104 primes as level 2 objects any objects referenced by key objects, and primes as level 3 objects any objects referenced by level 2 objects. As an example of depth-of-3 priming, if a service appointment object with ID SA-0001 references a custom jellybean object with ID JB-0002, and the custom jellybean object JB-0002 references an account object with ID AC-0003, all three are primed. In some examples, if a primed object references special object types designated for mandatory priming, those referenced objects are also primed. Special object types can include, as examples, account objects, assigned resource objects, case objects, contact objects, product objects, product consumed objects, product request objects, product request line item objects, product required objects, and product transfer objects. In some examples, the entire record for a product item object is not primed.

In some examples, if a record that is being primed is a key object, a set of up to twenty-five records in the related list are fully primed, meaning their record details, associated quick actions, and other data is all primed (downloaded) to the mobile device 102. In such examples, beyond this set of up to twenty-five records, record details only for the rest of the records in the related list are downloaded until a limit is hit. This limit can, for example, be determined by the total number of characters downloaded, so that the number of records downloaded may vary based on how much data is stored in each one. In some examples, this limit does not apply to the articles related list, which can be unlimited. In some examples, the related list fields are primed, but metadata pertaining to them is not primed. In some examples, a related list of type service reports or content document is always primed. In some examples, only metadata about the files, such as file name and version, is primed, and related file data is not primed.

In some examples, the field service technician's inventory is primed to the mobile device 102. In some examples, for multi-location inventory, the UI 104 can prime up to a limit of ten locations, and for each location, the UI can prime up to a limit of one thousand records. In some examples, service reports and previews associated with primed work orders and work order line items are primed. In some examples, knowledge articles are primed, e.g., using an embedded service knowledge software development kit (SDK). In some examples, based on object feeds being enabled, object feeds are primed for supported object types using a feed SDK offline priming feature. Supported objects for object feeds priming can include, as examples, asset, case, work order, product request, product request line item, service appointment, and work order line item objects. In some examples, for every object that is primed, the UI 104 can also prime page and search layouts. These pages and search layouts can contain one or more lists of quick actions for the corresponding object type. In some examples, based on a list view being specified, the work orders and service appointments from the list view can be primed.

In some examples, referenced active flows can be primed. In such examples, subflows can also be primed to a specified depth (e.g., to a depth of 5). Also in such examples, metadata and quick actions for referenced objects in a flow can be primed. Based on a priming fault occurring while priming a flow, e.g., based on a flow having an unsupported flow element, the flow can be excluded from priming. In some examples, price books can be excluded from priming for offline use for performance considerations.

A field service technician may be scheduled for new appointments or have appointment times or other appointment details updated appointments throughout a service day. The multi-tenant system can be configured, for example, to provide a notification (e.g., a text notification) to a field service technician's mobile device 102 when the field service technician's appointment schedule changes. Based on the UI 104 being in the foreground or background when the field service technician receives the notification, the new or updated service appointment data can automatically primed to the mobile device 102. Otherwise, if the UI 104 is not running on the mobile device 102, the new or updated service appointment and any associated records can be primed when the field service technician executes the UI 104 and/or activates the priming from the notification (e.g., by tapping a link or button provided with the notification on the mobile device 102).

A network error that occurs while records are being primed to the mobile device 102 can halt the priming process. The mobile device 102 may accordingly display an error message prompting for reconnection to the network. Priming can also stop when a multi-tenant environment server gets too many requests. In this case, the server may transmit to the mobile device 102 a time when the user can retry their request.

Priming of work order data, and in particular priming of a PromptTemplateId 318 stored in the work order data for a work order object, to a field service technician mobile device 102 in the context of implementations described herein can have the advantage at the prompt template ID can be provided to a generations endpoint of a connect API

### Electronic Device and Machine-Readable Media

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

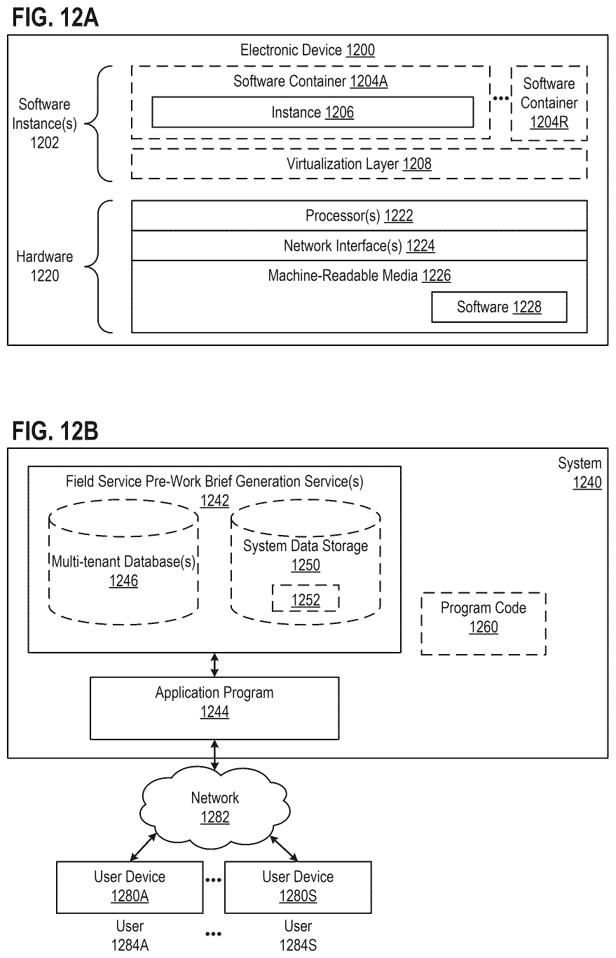

FIG. 12A is a block diagram illustrating an electronic device 1200 according to some example implementations. FIG. 12A includes hardware 1220 comprising a set of one or more processor(s) 1222, a set of one or more network interfaces 1224 (wireless and/or wired), and machine-readable media 1226 having stored therein software 1228 (which includes instructions executable by the set of one or more processor(s) 1222). The machine-readable media 1226 may include non-transitory and/or transitory machine-readable media. Each of the previously described clients and the field service pre-work brief generation service may be implemented in one or more electronic devices 1200. In one implementation: 1) each of the clients is implemented in a separate one of the electronic devices 1200 (e.g., in end user devices where the software 1228 represents the software to implement clients to interface directly and/or indirectly with the field service pre-work brief generation service (e.g., software 1228 represents a web browser, a native client, a portal, a command-line interface, and/or an API based upon protocols such as Simple Object Access Protocol (SOAP), Representational State Transfer (REST), etc.)); 2) the field service pre-work brief generation service is implemented in a separate set of one or more of the electronic devices 1200 (e.g., a set of one or more server devices where the software 1228 represents the software to implement the field service pre-work brief generation service); and 3) in operation, the electronic devices implementing the clients and the field service pre-work brief generation service would be communicatively coupled (e.g., by a network) and would establish between them (or through one or more other layers and/or or other services) connections for submitting pre-work brief generation requests and data, such as an AI prompt template ID and/or a field service technician user ID, to the field service pre-work brief generation service and returning a generated pre-work brief to the clients. Other configurations of electronic devices may be used in other implementations (e.g., an implementation in which the client and the field service pre-work brief generation service are implemented on a single one of electronic device 1200).

During operation, an instance of the software 1228 (illustrated as instance 1206 and referred to as a software instance; and in the more specific case of an application, as an application instance) is executed. In electronic devices that use compute virtualization, the set of one or more processor(s) 1222 typically execute software to instantiate a virtualization layer 1208 and one or more software container(s) 1204A-1204R (e.g., with operating system-level virtualization, the virtualization layer 1208 may represent a container engine (such as Docker Engine by Docker, Inc. or rkt in Container Linux by Red Hat, Inc.) running on top of (or integrated into) an operating system, and it allows for the creation of multiple software containers 1204A-1204R (representing separate user space instances and also called virtualization engines, virtual private servers, or jails) that may each be used to execute a set of one or more applications; with full virtualization, the virtualization layer 1208 represents a hypervisor (sometimes referred to as a virtual machine monitor (VMM)) or a hypervisor executing on top of a host operating system, and the software containers 1204A-1204R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 1228 is executed within the software container 1204A on the virtualization layer 1208. In electronic devices where compute virtualization is not used, the instance 1206 on top of a host operating system is executed on the “bare metal” electronic device 1200. The instantiation of the instance 1206, as well as the virtualization layer 1208 and software containers 1204A-1204R if implemented, are collectively referred to as software instance(s) 1202.

Alternative implementations of an electronic device may have numerous variations from that described above. For example, customized hardware and/or accelerators might also be used in an electronic device.

### Example Environment

FIG. 12B is a block diagram of a deployment environment according to some example implementations. A system 1240 includes hardware (e.g., a set of one or more server devices) and software to provide service(s) 1242, including the field service pre-work brief generation service. In some implementations the system 1240 is in one or more datacenter(s). These datacenter(s) may be: 1) first party datacenter(s), which are datacenter(s) owned and/or operated by the same entity that provides and/or operates some or all of the software that provides the service(s) 1242; and/or 2) third-party datacenter(s), which are datacenter(s) owned and/or operated by one or more different entities than the entity that provides the service(s) 1242 (e.g., the different entities may host some or all of the software provided and/or operated by the entity that provides the service(s) 1242). For example, third-party datacenters may be owned and/or operated by entities providing public cloud services (e.g., Amazon.com, Inc. (Amazon Web Services), Google LLC (Google Cloud Platform), Microsoft Corporation (Azure)).

The system 1240 is coupled to user devices 1280A-1280S over a network 1282. The service(s) 1242 may be on-demand services that are made available to one or more of the users 1284A-1284S working for one or more entities other than the entity which owns and/or operates the on-demand services (those users sometimes referred to as outside users) so that those entities need not be concerned with building and/or maintaining a system, but instead may make use of the service(s) 1242 when needed (e.g., when needed by the users 1284A-1284S). The service(s) 1242 may communicate with each other and/or with one or more of the user devices 1280A-1280S via one or more APIs (e.g., a REST API). In some implementations, the user devices 1280A-1280S are operated by users 1284A-1284S, and each may be operated as a client device and/or a server device. In some implementations, one or more of the user devices 1280A-1280S are separate ones of the electronic device 1200 or include one or more features of the electronic device 1200.

In some implementations, the system 1240 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PaaS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 1240 is a multi-tenant cloud computing architecture supporting multiple services, such as one or more of the following types of services: Field service pre-work brief generation service 1242, Customer relationship management (CRM); Configure, price, quote (CPQ); Business process modeling (BPM); Customer support; Marketing; External data connectivity; Productivity; Database-as-a-Service; DAAS; PaaS; Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Security; and Identity and access management (IAM). For example, system 1240 may include an application platform 1244 that enables PaaS for creating, managing, and executing one or more applications developed by the provider of the application platform 1244, users accessing the system 1240 via one or more of user devices 1280A-1280S, or third-party application developers accessing the system 1240 via one or more of user devices 1280A-1280S.

In some implementations, one or more of the service(s) 1242 may use one or more multi-tenant databases 1246, as well as system data storage 1250 for system data 1252 accessible to system 1240. In certain implementations, the system 1240 includes a set of one or more servers that are running on server electronic devices and that are configured to handle requests for any authorized user associated with any tenant (there is no server affinity for a user and/or tenant to a specific server). The user devices 1280A-1280S communicate with the server(s) of system 1240 to request and update tenant-level data and system-level data hosted by system 1240, and in response the system 1240 (e.g., one or more servers in system 1240) automatically may generate one or more SQL statements (e.g., one or more SQL queries) that are designed to access the desired information from the multi-tenant database(s) 1246 and/or system data storage 1250.

In some implementations, the service(s) 1242 are implemented using virtual applications dynamically created at run time responsive to queries from the user devices 1280A-1280S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 1260 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 1244 includes an application setup mechanism that supports application developers' creation and management of applications, which may be saved as metadata by save routines. Invocations to such applications, including the field service pre-work brief generation service, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 1282 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4th generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 1240 and the user devices 1280A-1280S.

Each user device 1280A-1280S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 1240. For example, the user interface device can be used to access data and applications hosted by system 1240, and to perform searches on stored data, and otherwise allow one or more of users 1284A-1284S to interact with various GUI pages that may be presented to the one or more of users 1284A-1284S. User devices 1280A-1280S might communicate with system 1240 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an API based upon protocols such as Simple Object Access Protocol (SOAP), Representational State Transfer (REST), etc. In an example where HTTP is used, one or more user devices 1280A-1280S might include an HTTP client, commonly referred to as a “browser,” for sending and receiving HTTP messages to and from server(s) of system 1240, thus allowing users 1284A-1284S of the user devices 1280A-1280S to access, process and view information, pages and applications available to it from system 1240 over network 1282.

### Example Computer System

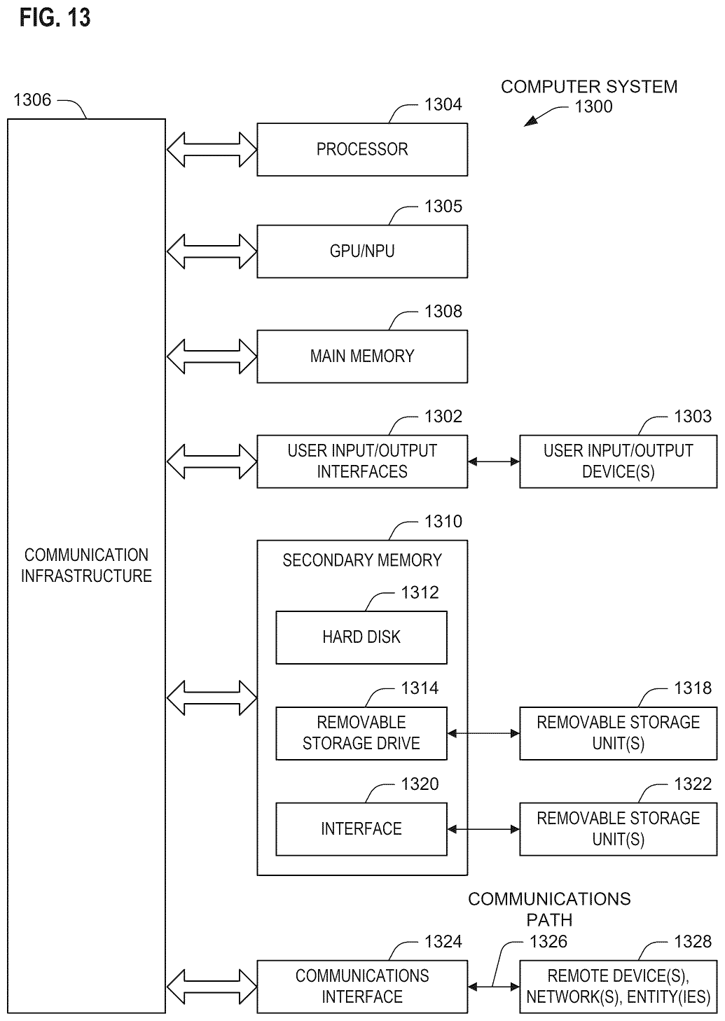

Various embodiments or aspects of embodiments may be implemented, for example, using one or more computer systems, such as computer system 1300 shown in FIG. 13. One or more computer systems 1300 may be used, for example, to implement any of the embodiments discussed herein, as well as combinations and sub-combinations thereof. For example, one or more computer systems 1300 may be used to implement any of field service pre-work brief generation service 108 or 200, generative AI 123, technician mobile device 102, electronic device 1200, system 1240, and/or other systems or devices, such as may be used to provide access to prompt template datastore 110, user datastore 114, and/or work order datastore 118.

One or more computer systems 1300 may be used to implement prompt builder 500. One or more computer systems 1300 may be used to implement the methods of FIGS. 6 through 11.

Computer system 1300 can include one or more processors (also called central processing units, or CPUs), such as a processor 1304. Processor 1304 may be connected to a communication infrastructure or bus 1306. Computer system 1300 may also include user input/output device(s) 1303, such as one or more monitors, keyboards, pointing devices, etc., which may communicate with communication infrastructure 1306 through user input/output interface(s) 1302.

Computer system 1300 can include a graphics processing unit (GPU) and/or neural processing unit (NPU) 1305. In various embodiments, a GPU and/or an NPU can be a specialized electronic circuit processor designed to process mathematically intensive applications. The GPU and/or NPU may have a parallel structure that is efficient for parallel processing of large blocks of data, such as mathematically intensive data common to computer graphics applications, images, videos, machine learning or artificial intelligence operations, etc. For example, the GPU and/or NPU 1305 may be used for training or inferencing of generative AI model 126 in FIG. 1.

Computer system 1300 may also include a main or primary memory 1308, such as random access memory (RAM). Main memory 1308 may include one or more levels of cache. Main memory 1308 may have stored therein control logic (i.e., computer software) and/or data.

Computer system 1300 may also include one or more secondary storage devices or memory 1310. Secondary memory 1310 may include, for example, a hard disk drive 1312 and/or a removable storage device or drive 1314. Removable storage drive 1314 may be a floppy disk drive, a magnetic tape drive, a compact disk drive, an optical storage device, a tape backup device, and/or any other storage device or drive. Removable storage drive 1314 may interact with a removable storage unit 1318. Removable storage unit 1318 may include a computer-usable or readable storage device having stored thereon computer software (control logic) and/or data. Removable storage unit 1318 may be a floppy disk, magnetic tape, compact disk, DVD, optical storage disk, and/or any other computer data storage device. Removable storage drive 1314 may read from and/or write to removable storage unit 1318.

Secondary memory 1310 may include other means, devices, components, instrumentalities, or other approaches for allowing computer programs and/or other instructions and/or data to be accessed by computer system 1300. Such means, devices, components, instrumentalities, or other approaches may include, for example, a removable storage unit 1322 and an interface 1320. Examples of the removable storage unit 1322 and the interface 1320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1300 may further include a communication or network interface 1324. Communication interface 1324 may enable computer system 1300 to communicate and interact with any combination of external devices, external networks, external entities, etc. (individually and collectively referenced by reference number 1328). For example, communication interface 1324 may allow computer system 1300 to communicate with external or remote devices 1328 over communications path 1326, which may be wired and/or wireless (or a combination thereof) and which may include any combination of LANs, WANs, the internet, etc. Control logic and/or data may be transmitted to and from computer system 1300 via communication path 1326. Communications path 1326 can be used, for example, to transfer data and/or instructions indicated by connections 106, 122, 128, and 130 in FIGS. 1 and 2.

Computer system 1300 may be any of a data center server, a personal digital assistant (PDA), a desktop workstation, a laptop or notebook computer, a netbook, a tablet, a smart phone, a smart watch or other wearable, an appliance, a part of the Internet-of-Things, and/or and embedded system, to name a few non-limiting examples, or any combination thereof.

Computer system 1300 may be a client or server, accessing or hosting any applications and/or data through any delivery paradigm, including but not limited to remote or distributed cloud computing solutions; local or on-premises software (e.g., on-premises cloud-based solutions); “as a service” models (e.g., content as a service (CaaS), digital content as a service (DCaaS), software as a service (SaaS), managed software as a service (MSaaS), PaaS, desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1300 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1300, main memory 1308, secondary memory 1310, and removable storage units 1318 and 1322, as well as tangible articles of manufacture embodying any combination of the foregoing. Such control logic, when executed by one or more data processing devices (such as computer system 1300), may cause such data processing devices to operate as described herein.

Based on the teachings contained in this disclosure, it will be apparent to persons skilled in the relevant art(s) how to make and use embodiments of this disclosure using data processing devices, computer systems, and/or computer architectures other than that shown in FIG. 13. In particular, embodiments can operate with software, hardware, and/or operating system implementations other than those described herein.

### Conclusion

In the above description, numerous specific details such as resource partitioning/sharing/duplication implementations, types and interrelationships of system components, and logic partitioning/integration choices are set forth in order to provide a more thorough understanding. Implementations may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A non-transitory machine-readable storage medium that provides instructions that, if executed by a set of one or more processors, are configurable to cause said set of one or more processors to perform operations comprising:
generating a generative artificial intelligence (AI) prompt based on:
a generative AI prompt template retrieved from a prompt template datastore based on work order data retrieved from a work order datastore, the work order data retrieved based on a technician user identifier associated with an instruction to generate a pre-work brief, the instruction received by the set of one or more processors, and
the work order data;
obtaining the pre-work brief as an output of a generative AI based on providing the generative AI prompt to the generative AI; and
transmitting the pre-work brief to a mobile device associated with the technician user identifier.

2. The machine-readable storage medium of claim 1, wherein the instruction is received from the mobile device of the technician user.

3. The machine-readable storage medium of claim 2, wherein the prompt template is retrieved based on a prompt template identifier received from the mobile device.

4. The machine-readable storage medium of claim 3, wherein the prompt template identifier is an attribute of a work order object primed to the mobile device.

5. The machine-readable storage medium of claim 4, wherein the work order object comprises an overridden method function configured to select the prompt template identifier and write the prompt template identifier to the work order object based on one or more other attributes of the work order object.

6. The machine-readable storage medium of claim 5, wherein the work order data comprises attributes of the work order object, and wherein the generating the generative AI prompt comprises hydrating the prompt template with one or more attributes of the work order object.

7. The machine-readable storage medium of claim 6, wherein the generating the generative AI prompt is further based on user data associated with the technician user identifier.

8. The machine-readable storage medium of claim 7, wherein the generating the generative AI prompt is based on a preferred language of the technician user specified as an attribute of a user object stored in a user datastore and associated with the technician user.

9. The machine-readable storage medium of claim 1, wherein the retrieving the work order data comprises building a data query language (DQL) query and executing the DQL query against the work order datastore.

10. A computer-implemented method comprising:
generating, by one or more computer processors, a generative artificial intelligence (AI) prompt based on:
a generative AI prompt template retrieved from a prompt template datastore based on work order data retrieved from a work order datastore, the work order data retrieved based on a technician user identifier associated with an instruction to generate a pre-work brief, the instruction received by the one or more computer processors, and
the work order data;
obtaining, by the one or more computer processors, the pre-work brief as an output of a generative AI based on providing the generative AI prompt to the generative AI; and
transmitting, by the one or more computer processors, the pre-work brief to a mobile device of the technician associated with the technician user identifier.

11. The method of claim 10, wherein the instruction is received from the mobile device of the technician user.

12. The method of claim 11, wherein the prompt template is retrieved based on a prompt template identifier received from the mobile device.

13. The method of claim 12, wherein the prompt template identifier is an attribute of a work order object primed to the mobile device.

14. The method of claim 13, wherein the work order object comprises an overridden method function configured to select the prompt template identifier and write the prompt template identifier to the work order object based on one or more other attributes of the work order object.

15. The method of claim 14, wherein the work order data comprises attributes of the work order object, and wherein the generating the generative AI prompt comprises hydrating the prompt template with one or more attributes of the work order object.

16. The method of claim 15, wherein the generating the generative AI prompt is further based on user data associated with the technician user identifier.

17. The method of claim 16, wherein the generating the generative AI prompt is based on a preferred language of the technician user specified as an attribute of a user object stored in a user datastore and associated with the technician user.

18. The method of claim 10, wherein the retrieving the work order data comprises building a data query language (DQL) query based on an identifier of the technician user and executing the DQL query against the work order datastore.

19. The method of claim 10, wherein the retrieving the prompt template comprises building a data query language (DQL) query based on a prompt template identifier in the work order data and executing the DQL query against the prompt template datastore.

20. An apparatus comprising:
a set of one or more processors;
a non-transitory machine-readable storage medium that provides instructions that, if executed by the set of one or more processors, are configurable to cause the apparatus to perform operations comprising:
generating a generative artificial intelligence (AI) prompt based on:
a generative AI prompt template retrieved from a prompt template datastore based on work order data retrieved from a work order datastore, the work order data retrieved based on a technician user identifier associated with an instruction to generate a pre-work brief, the instruction received by the set of one or more processors, and
the work order data;
obtaining the pre-work brief as an output of a generative AI based on providing the generative AI prompt to the generative AI; and
transmitting the pre-work brief to a mobile device of a technician user associated with the technician user identifier.
